(19) United States
(12) Patent Application Publication
(10) Pub. No.: US 2025/0150243 A1
(43) Pub. Date: May 8, 2025

(54) TCI Configuration for Multi-Beam Indication

(71) Applicant: Apple Inc., Cupertino, CA (US)

(72) Inventors: Yushu Zhang, Beijing (CN); Oghenekome Oteri, San Diego, CA (US); Huaning Niu, San Jose, CA (US); Chunxuan Ye, San Diego, CA (US); Seyed Ali Akbar Fakoorian, San Diego, CA (US); Wei Zeng, San Diego, CA (US); Haitong Sun, Cupertino, CA (US); Hong He, Cupertino, CA (US); Dawei Zhang, Saratoga, CA (US)

(21) Appl. No.: 18/834,992

(22) PCT Filed: Mar. 1, 2022
(86) PCT No.: PCT/CN2022/078615

§ 371 Date: Jul. 31, 2024

(51) Int. Cl. H04L 5/00; H04B 7/06

(52) U.S. Cl. CPC H04L 5/0092; H04B 7/0626; H04B 7/06968; H04L 5/0044

(57) ABSTRACT

Apparatuses, systems, and methods for Unified transmission configuration indicator (TCI) configuration and default beam for multi-beam indication, e.g., in 5G NR systems and beyond, including systems, methods, and mechanisms for supporting cross-cell TCI state list sharing and common TCI ID indication with regard to different multi-TRP operation in different serving cells as well as for determining which TCI to use to buffer data when a scheduling offset is below a threshold when multiple TCI states are indicated (e.g., which TCI state is a default TCI state).

### PRIORITY INFORMATION

This application is a national phase entry of PCT Application No PCT/CN2022/078615, entitled “TCI Configuration for Multi-Beam Indication,” filed Mar. 1, 2022, which is hereby incorporated by reference in its entirety as though fully and completely set forth herein. The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, any disclaimer made in the instant application should not be read into or against the parent application or other related applications.

### FIELD

The invention relates to wireless communications, and more particularly to apparatuses, systems, and methods for unified transmission configuration indicator (TCI) configuration and default beam selection for multi-beam indication, e.g., in 5G NR systems and beyond.

### Description of the Related Art

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS), and are capable of operating sophisticated applications that utilize these functionalities.

Long Term Evolution (LTE) is currently the technology of choice for the majority of wireless network operators worldwide, providing mobile broadband data and high-speed Internet access to their subscriber base. LTE was first proposed in 2004 and was first standardized in 2008. Since then, as usage of wireless communication systems has expanded exponentially, demand has risen for wireless network operators to support a higher capacity for a higher density of mobile broadband users. Thus, in 2015 study of a new radio access technology began and, in 2017, a first release of Fifth Generation New Radio (5G NR) was standardized.

5G-NR, also simply referred to as NR, provides, as compared to LTE, a higher capacity for a higher density of mobile broadband users, while also supporting device-to-device, ultra-reliable, and massive machine type communications with lower latency and/or lower battery consumption. Further, NR may allow for more flexible UE scheduling as compared to current LTE. Consequently, efforts are being made in ongoing developments of 5G-NR to take advantage of higher throughputs possible at higher frequencies.

### SUMMARY

Embodiments relate to wireless communications, and more particularly to apparatuses, systems, and methods for unified TCI configuration and default beam selection (e.g., identification and/or determination) for multi-beam indication, e.g., in 5G NR systems and beyond.

For example, in some embodiments, a user equipment device (UE) may be configured to receive, from a base station, at least one transmission configuration indicator (TCI) state list corresponding to one or more transmission-reception points (TRPs). The UE may be configured to determine, based, at least in part, on the at least one TCI state list, an operational mode for one or more serving cells associated with the one or more TRPs. Further, the UE may be configured to communicate with the one or more serving cells according to the determined operational mode. Note that when a TCI state list is not configured for a serving cell of the one or more serving cells, the UE may be configured to receive, from the base station, an indication of at least one of a reference bandwidth part, a reference component carrier, or a reference TRP for the serving cell.

As another example, in some embodiments, the UE may be configured to receive, from a base station, a TCI state list for multi-TRP operation. The UE may be configured to determine, based, at least in part, on the TCI state list, an operational mode for one or more serving cells associated with the TCI state list and communicate with the one or more serving cells according to the determined operational mode. Additionally, the UE may be configured to receive, from the base station, an indication of at least one of a reference bandwidth part or reference component carrier for a serving cell of the one or more serving cells. The indication may identify an additional TCI state list for multi-TRP operation.

As a further example, in some embodiments, the UE may be configured to receive, from a base station, a plurality of transmission configuration indicator (TCI) state lists. The UE may be configured to determine a default beam to buffer downlink data to receive an aperiodic Channel State Information (CSI) reference signal (CSI-RS) or a physical downlink shared channel (PDSCH) with a scheduling offset less than a threshold based, at least in part, on common TCI states included in a TCI state list for a serving cell indicated in one of a medium access control (MAC) control element (CE) or downlink control information (DCI) received from the base station. Further, the UE may be configured to buffer the downlink data using the determined default beam.

As a yet further example, in some embodiments, the UE may be configured to receive, from a base station, a plurality of transmission configuration indicator (TCI) state lists. The UE may be configured to determine a default beam to buffer downlink data to receive an aperiodic Channel State Information (CSI) reference signal (CSI-RS) or a physical downlink shared channel (PDSCH) with a scheduling offset less than a threshold based on at least one of quasi-co-location (QCL) assumption or TCI states for Control Resource Sets (CORESETs) in a most recent slot. Additionally, the UE may be configured to buffer the downlink data using the determined default beam.

The techniques described herein may be implemented in and/or used with a number of different types of devices, including but not limited to unmanned aerial vehicles (UAVs), unmanned aerial controllers (UACs), a UTM server, base stations, access points, cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1A illustrates an example wireless communication system according to some embodiments.

FIG. 1B illustrates an example of a base station and an access point in communication with a user equipment (UE) device, according to some embodiments.

FIG. 2 illustrates an example block diagram of a base station, according to some embodiments.

FIG. 3 illustrates an example block diagram of a server according to some embodiments.

FIG. 4 illustrates an example block diagram of a UE according to some embodiments.

FIG. 5 illustrates an example block diagram of cellular communication circuitry, according to some embodiments.

FIG. 6A illustrates an example of a 5G network architecture that incorporates both 3GPP (e.g., cellular) and non-3GPP (e.g., non-cellular) access to the 5G CN, according to some embodiments.

FIG. 6B illustrates an example of a 5G network architecture that incorporates both dual 3GPP (e.g., LTE and 5G NR) access and non-3GPP access to the 5G CN, according to some embodiments.

FIG. 7 illustrates an example of a baseband processor architecture for a UE, according to some embodiments.

FIGS. 8A, 8B, 8C, and 8D illustrate examples of the unified TCI state based beam indication framework.

FIG. 9 illustrates an example of common TCI ID indication for multiple component carriers (CCs).

FIGS. 10 and 11 illustrate block diagrams of examples of methods for supporting a multi-beam indication, according to some embodiments.

FIGS. 12 and 13 illustrate block diagrams of examples of methods for determining a default beam to buffer downlink data, according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
3GPP: Third Generation Partnership Project
UE: User Equipment
RF: Radio Frequency
DL: Downlink
UL: Uplink
LTE: Long Term Evolution
NR: New Radio
5GS: 5G System
5GMM: 5GS Mobility Management
5GC/5GCN: 5G Core Network
IE: Information Element
CE: Control Element
MAC: Medium Access Control
SSB: Synchronization Signal Block
CSI: Channel State Information
CSI-RS: Channel State Information Reference Signal
CMR: Channel Measurement Resource.
PDCCH: Physical Downlink Control Channel.
PDSCH: Physical Downlink Shared Channel
RRC: Radio Resource Control
RRM: Radio Resource Management
CORESET: Control Resource Set
TCI: Transmission Configuration Indicator
DCI: Downlink Control Indicator

### Terms

The following is a glossary of terms used in this disclosure:

Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g., smart watch, smart glasses), PDAS, portable Internet devices, music players, data storage devices, other handheld devices, unmanned aerial vehicles (UAVs) (e.g., drones), UAV controllers (UACs), and so forth. In general, the term “UE” or “UE device” can be broadly defined to encompass any electronic, computing, and/or telecommunications device (or combination of devices) which is easily transported by a user and capable of wireless communication.

Base Station—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Wi-Fi—The term “Wi-Fi” (or WiFi) has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

3GPP Access—refers to accesses (e.g., radio access technologies) that are specified by 3GPP standards. These accesses include, but are not limited to, GSM/GPRS, LTE, LTE-A, and/or 5G NR. In general, 3GPP access refers to various types of cellular access technologies.

Non-3GPP Access—refers any accesses (e.g., radio access technologies) that are not specified by 3GPP standards. These accesses include, but are not limited to, WiMAX, CDMA2000, Wi-Fi, WLAN, and/or fixed networks. Non-3GPP accesses may be split into two categories, “trusted” and “untrusted”: Trusted non-3GPP accesses can interact directly with an evolved packet core (EPC) and/or a 5G core (5GC) whereas untrusted non-3GPP accesses interwork with the EPC/5GC via a network entity, such as an Evolved Packet Data Gateway and/or a 5G NR gateway. In general, non-3GPP access refers to various types on non-cellular access technologies.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as required by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112 (f) interpretation for that component.

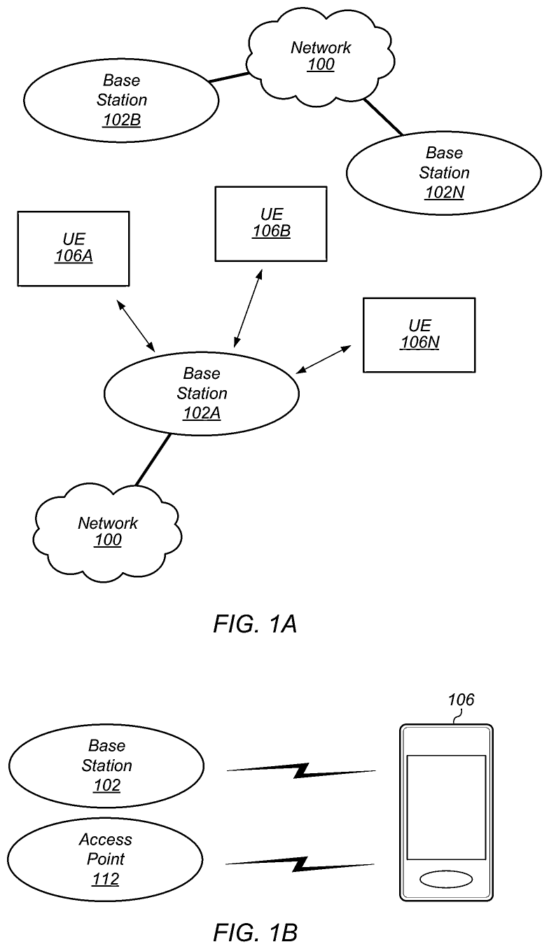

### FIGS. 1A and 1B: Communication Systems

FIG. 1A illustrates a simplified example wireless communication system, according to some embodiments. It is noted that the system of FIG. 1A is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1×RTT, 1×EV-DO, HRPD, eHRPD), etc. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’ or ‘gNB’

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1×RTT, 1×EV-DO, HRPD, cHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

FIG. 1B illustrates user equipment 106 (e.g., one of the devices 106A through 106N) in communication with a base station 102 and an access point 112, according to some embodiments. The UE 106 may be a device with both cellular communication capability and non-cellular communication capability (e.g., Bluetooth, Wi-Fi, and so forth) such as a mobile phone, a hand-held device, a computer or a tablet, or virtually any type of wireless device.

The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, CDMA2000 (1×RTT/1×EV-DO/HRPD/CHRPD), LTE/LTE-Advanced, or 5G NR using a single shared radio and/or GSM, LTE, LTE-Advanced, or 5G NR using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or LTE or 1×RTT or LTE or GSM), and separate radios for communicating using each of Wi-Fi and Bluetooth. Other configurations are also possible.

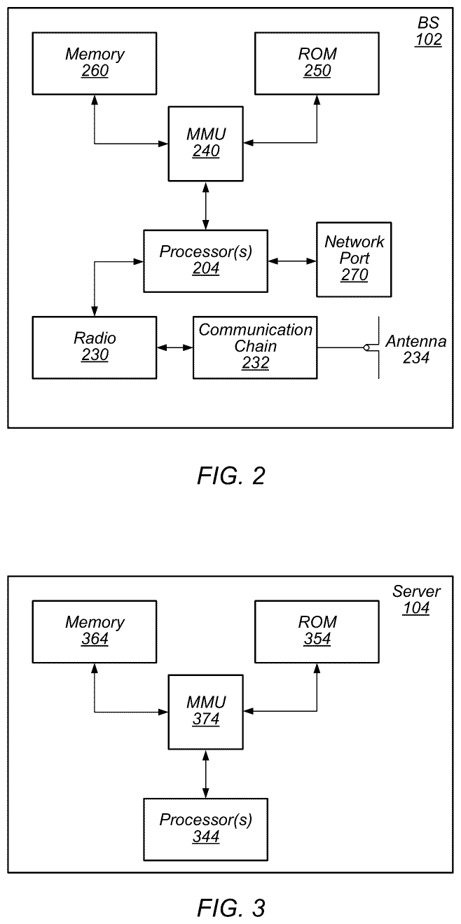

### FIG. 2: Block Diagram of a Base Station

FIG. 2 illustrates an example block diagram of a base station 102, according to some embodiments. It is noted that the base station of FIG. 3 is merely one example of a possible base station. As shown, the base station 102 may include processor(s) 204 which may execute program instructions for the base station 102. The processor(s) 204 may also be coupled to memory management unit (MMU) 240, which may be configured to receive addresses from the processor(s) 204 and translate those addresses to locations in memory (e.g., memory 260 and read only memory (ROM) 250) or to other circuits or devices.

The base station 102 may include at least one network port 270. The network port 270 may be configured to couple to a telephone network and provide a plurality of devices, such as UE devices 106, access to the telephone network as described above in FIGS. 1 and 2.

The network port 270 (or an additional network port) may also or alternatively be configured to couple to a cellular network, e.g., a core network of a cellular service provider. The core network may provide mobility related services and/or other services to a plurality of devices, such as UE devices 106. In some cases, the network port 270 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 234, and possibly multiple antennas. The at least one antenna 234 may be configured to operate as a wireless transceiver and may be further configured to communicate with UE devices 106 via radio 230. The antenna 234 communicates with the radio 230 via communication chain 232. Communication chain 232 may be a receive chain, a transmit chain or both. The radio 230 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 204 of the base station 102 may be configured to implement or support implementation of part or all of the methods described herein, e.g., by executing program instructions stored on a memory medium (e.g., a non-transitory computer-readable memory medium). Alternatively, the processor 204 may be configured as a programmable hardware element, such as an FPGA (Field Programmable Gate Array), or as an ASIC (Application Specific Integrated Circuit), or a combination thereof. Alternatively (or in addition) the processor 204 of the BS 102, in conjunction with one or more of the other components 230, 232, 234, 240, 250, 260, 270 may be configured to implement or support implementation of part or all of the features described herein.

In addition, as described herein, processor(s) 204 may be comprised of one or more processing elements. In other words, one or more processing elements may be included in processor(s) 204. Thus, processor(s) 204 may include one or more integrated circuits (ICs) that are configured to perform the functions of processor(s) 204. In addition, each integrated circuit may include circuitry (e.g., first circuitry, second circuitry, etc.) configured to perform the functions of processor(s) 204.

Further, as described herein, radio 230 may be comprised of one or more processing elements. In other words, one or more processing elements may be included in radio 230. Thus, radio 230 may include one or more integrated circuits (ICs) that are configured to perform the functions of radio 230. In addition, each integrated circuit may include circuitry (e.g., first circuitry, second circuitry, etc.) configured to perform the functions of radio 230.

### FIG. 3: Block Diagram of a Server

FIG. 3 illustrates an example block diagram of a server 104, according to some embodiments. It is noted that the server of FIG. 3 is merely one example of a possible server. As shown, the server 104 may include processor(s) 344 which may execute program instructions for the server 104. The processor(s) 344 may also be coupled to memory management unit (MMU) 374, which may be configured to receive addresses from the processor(s) 344 and translate those addresses to locations in memory (e.g., memory 364 and read only memory (ROM) 354) or to other circuits or devices.

The server 104 may be configured to provide a plurality of devices, such as base station 102, UE devices 106, and/or UTM 108, access to network functions, e.g., as further described herein.

In some embodiments, the server 104 may be part of a radio access network, such as a 5G New Radio (5G NR) radio access network. In some embodiments, the server 104 may be connected to a legacy evolved packet core (EPC) network and/or to a NR core (NRC) network.

As described further subsequently herein, the server 104 may include hardware and software components for implementing or supporting implementation of features described herein. The processor 344 of the server 104 may be configured to implement or support implementation of part or all of the methods described herein, e.g., by executing program instructions stored on a memory medium (e.g., a non-transitory computer-readable memory medium). Alternatively, the processor 344 may be configured as a programmable hardware element, such as an FPGA (Field Programmable Gate Array), or as an ASIC (Application Specific Integrated Circuit), or a combination thereof. Alternatively (or in addition) the processor 344 of the server 104, in conjunction with one or more of the other components 354, 364, and/or 374 may be configured to implement or support implementation of part or all of the features described herein.

In addition, as described herein, processor(s) 344 may be comprised of one or more processing elements. In other words, one or more processing elements may be included in processor(s) 344. Thus, processor(s) 344 may include one or more integrated circuits (ICs) that are configured to perform the functions of processor(s) 344. In addition, each integrated circuit may include circuitry (e.g., first circuitry, second circuitry, etc.) configured to perform the functions of processor(s) 344.

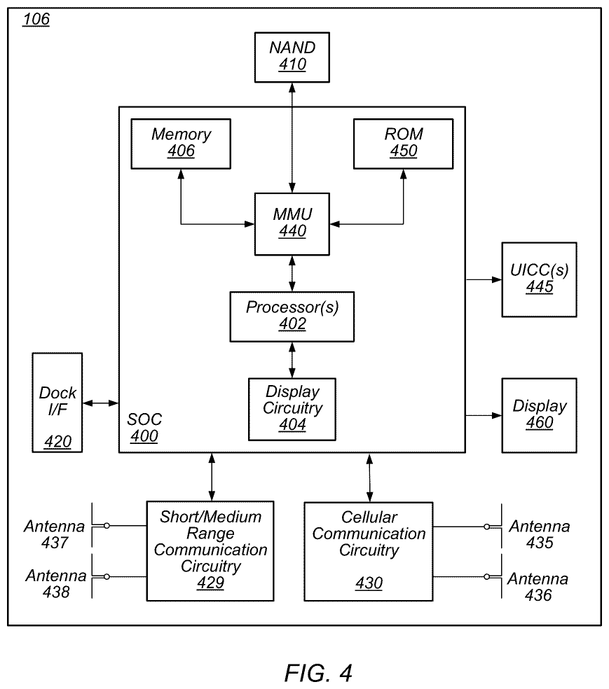

### FIG. 4: Block Diagram of a UE

FIG. 4 illustrates an example simplified block diagram of a communication device 106, according to some embodiments. It is noted that the block diagram of the communication device of FIG. 4 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet, an unmanned aerial vehicle (UAV), a UAV controller (UAC) and/or a combination of devices, among other devices. As shown, the communication device 106 may include a set of components 400 configured to perform core functions. For example, this set of components may be implemented as a system on chip (SOC), which may include portions for various purposes. Alternatively, this set of components 400 may be implemented as separate components or groups of components for the various purposes. The set of components 400 may be coupled (e.g., communicatively; directly or indirectly) to various other circuits of the communication device 106.

For example, the communication device 106 may include various types of memory (e.g., including NAND flash 410), an input/output interface such as connector I/F 420 (e.g., for connecting to a computer system; dock; charging station; input devices, such as a microphone, camera, keyboard; output devices, such as speakers; etc.), the display 460, which may be integrated with or external to the communication device 106, and cellular communication circuitry 430 such as for 5G NR, LTE, GSM, etc., and short to medium range wireless communication circuitry 429 (e.g., Bluetooth™ and WLAN circuitry). In some embodiments, communication device 106 may include wired communication circuitry (not shown), such as a network interface card, e.g., for Ethernet.

The cellular communication circuitry 430 may couple (e.g., communicatively; directly or indirectly) to one or more antennas, such as antennas 435 and 436 as shown. The short to medium range wireless communication circuitry 429 may also couple (e.g., communicatively; directly or indirectly) to one or more antennas, such as antennas 437 and 438 as shown. Alternatively, the short to medium range wireless communication circuitry 429 may couple (e.g., communicatively; directly or indirectly) to the antennas 435 and 436 in addition to, or instead of, coupling (e.g., communicatively; directly or indirectly) to the antennas 437 and 438. The short to medium range wireless communication circuitry 429 and/or cellular communication circuitry 430 may include multiple receive chains and/or multiple transmit chains for receiving and/or transmitting multiple spatial streams, such as in a multiple-input multiple output (MIMO) configuration.

In some embodiments, as further described below, cellular communication circuitry 430 may include dedicated receive chains (including and/or coupled to, e.g., communicatively; directly or indirectly. dedicated processors and/or radios) for multiple RATs (e.g., a first receive chain for LTE and a second receive chain for 5G NR). In addition, in some embodiments, cellular communication circuitry 430 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 460 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 445 that include SIM (Subscriber Identity Module) functionality, such as one or more UICC(s) (Universal Integrated Circuit Card(s)) cards 445. Note that the term “SIM” or “SIM entity” is intended to include any of various types of SIM implementations or SIM functionality, such as the one or more UICC(s) cards 445, one or more eUICCs, one or more eSIMs, either removable or embedded, etc. In some embodiments, the UE 106 may include at least two SIMs. Each SIM may execute one or more SIM applications and/or otherwise implement SIM functionality. Thus, each SIM may be a single smart card that may be embedded, e.g., may be soldered onto a circuit board in the UE 106, or each SIM 410 may be implemented as a removable smart card. Thus, the SIM(s) may be one or more removable smart cards (such as UICC cards, which are sometimes referred to as “SIM cards”), and/or the SIMS 410 may be one or more embedded cards (such as embedded UICCs (eUICCs), which are sometimes referred to as “eSIMs” or “eSIM cards”). In some embodiments (such as when the SIM(s) include an eUICC), one or more of the SIM(s) may implement embedded SIM (eSIM) functionality; in such an embodiment, a single one of the SIM(s) may execute multiple SIM applications. Each of the SIMs may include components such as a processor and/or a memory; instructions for performing SIM/eSIM functionality may be stored in the memory and executed by the processor. In some embodiments, the UE 106 may include a combination of removable smart cards and fixed/non-removable smart cards (such as one or more eUICC cards that implement eSIM functionality), as desired. For example, the UE 106 may comprise two embedded SIMs, two removable SIMs, or a combination of one embedded SIMs and one removable SIMs. Various other SIM configurations are also contemplated.

As noted above, in some embodiments, the UE 106 may include two or more SIMs. The inclusion of two or more SIMs in the UE 106 may allow the UE 106 to support two different telephone numbers and may allow the UE 106 to communicate on corresponding two or more respective networks. For example, a first SIM may support a first RAT such as LTE, and a second SIM 410 support a second RAT such as 5G NR. Other implementations and RATs are of course possible. In some embodiments, when the UE 106 comprises two SIMs, the UE 106 may support Dual SIM Dual Active (DSDA) functionality. The DSDA functionality may allow the UE 106 to be simultaneously connected to two networks (and use two different RATs) at the same time, or to simultaneously maintain two connections supported by two different SIMs using the same or different RATs on the same or different networks. The DSDA functionality may also allow the UE 106 to simultaneously receive voice calls or data traffic on either phone number. In certain embodiments the voice call may be a packet switched communication. In other words, the voice call may be received using voice over LTE (VOLTE) technology and/or voice over NR (VoNR) technology. In some embodiments, the UE 106 may support Dual SIM Dual Standby (DSDS) functionality. The DSDS functionality may allow either of the two SIMs in the UE 106 to be on standby waiting for a voice call and/or data connection. In DSDS, when a call/data is established on one SIM, the other SIM is no longer active. In some embodiments, DSDx functionality (either DSDA or DSDS functionality) may be implemented with a single SIM (e.g., a eUICC) that executes multiple SIM applications for different carriers and/or RATs.

As shown, the SOC 400 may include processor(s) 402, which may execute program instructions for the communication device 106 and display circuitry 404, which may perform graphics processing and provide display signals to the display 460. The processor(s) 402 may also be coupled to memory management unit (MMU) 440, which may be configured to receive addresses from the processor(s) 402 and translate those addresses to locations in memory (e.g., memory 406, read only memory (ROM) 450, NAND flash memory 410) and/or to other circuits or devices, such as the display circuitry 404, short to medium range wireless communication circuitry 429, cellular communication circuitry 430, connector I/F 420, and/or display 460. The MMU 440 may be configured to perform memory protection and page table translation or set up. In some embodiments, the MMU 440 may be included as a portion of the processor(s) 402.

As noted above, the communication device 106 may be configured to communicate using wireless and/or wired communication circuitry. The communication device 106 may be configured to perform methods for unified TCI configuration and default beam selection (e.g., identification and/or determination) for multi-beam indication, e.g., in 5G NR systems and beyond, as further described herein.

As described herein, the communication device 106 may include hardware and software components for implementing the above features for a communication device 106 to communicate a scheduling profile for power savings to a network. The processor 402 of the communication device 106 may be configured to implement part or all of the features described herein, e.g., by executing program instructions stored on a memory medium (e.g., a non-transitory computer-readable memory medium). Alternatively (or in addition), processor 402 may be configured as a programmable hardware element, such as an FPGA (Field Programmable Gate Array), or as an ASIC (Application Specific Integrated Circuit). Alternatively (or in addition) the processor 402 of the communication device 106, in conjunction with one or more of the other components 400, 404, 406, 410, 420, 429, 430, 440, 445, 450, 460 may be configured to implement part or all of the features described herein.

In addition, as described herein, processor 402 may include one or more processing elements. Thus, processor 402 may include one or more integrated circuits (ICs) that are configured to perform the functions of processor 402. In addition, each integrated circuit may include circuitry (e.g., first circuitry, second circuitry, etc.) configured to perform the functions of processor(s) 402.

Further, as described herein, cellular communication circuitry 430 and short to medium range wireless communication circuitry 429 may each include one or more processing elements. In other words, one or more processing elements may be included in cellular communication circuitry 430 and, similarly, one or more processing elements may be included in short to medium range wireless communication circuitry 429. Thus, cellular communication circuitry 430 may include one or more integrated circuits (ICs) that are configured to perform the functions of cellular communication circuitry 430. In addition, each integrated circuit may include circuitry (e.g., first circuitry, second circuitry, etc.) configured to perform the functions of cellular communication circuitry 430. Similarly, the short to medium range wireless communication circuitry 429 may include one or more ICs that are configured to perform the functions of short to medium range wireless communication circuitry 429. In addition, each integrated circuit may include circuitry (e.g., first circuitry, second circuitry, etc.) configured to perform the functions of short to medium range wireless communication circuitry 429.

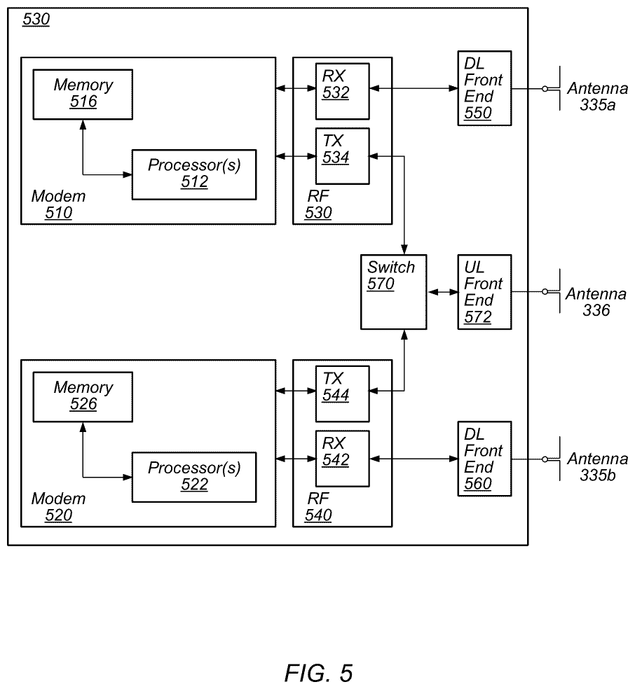

### FIG. 5: Block Diagram of Cellular Communication Circuitry

FIG. 5 illustrates an example simplified block diagram of cellular communication circuitry, according to some embodiments. It is noted that the block diagram of the cellular communication circuitry of FIG. 5 is only one example of a possible cellular communication circuit. According to embodiments, cellular communication circuitry 530, which may be cellular communication circuitry 430, may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 530 may couple (e.g., communicatively; directly or indirectly) to one or more antennas, such as antennas 435a-b and 436 as shown (in FIG. 4). In some embodiments, cellular communication circuitry 530 may include dedicated receive chains (including and/or coupled to, e.g., communicatively; directly or indirectly. dedicated processors and/or radios) for multiple RATs (e.g., a first receive chain for LTE and a second receive chain for 5G NR). For example, as shown in FIG. 5, cellular communication circuitry 530 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 530 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 530 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

In some embodiments, the cellular communication circuitry 530 may be configured to perform methods for unified TCI configuration and default beam selection (e.g., identification and/or determination) for multi-beam indication, e.g., in 5G NR systems and beyond, as further described herein.

As described herein, the modem 510 may include hardware and software components for implementing the above features or for time division multiplexing UL data for NSA NR operations, as well as the various other techniques described herein. The processors 512 may be configured to implement part or all of the features described herein, e.g., by executing program instructions stored on a memory medium (e.g., a non-transitory computer-readable memory medium). Alternatively (or in addition), processor 512 may be configured as a programmable hardware element, such as an FPGA (Field Programmable Gate Array), or as an ASIC (Application Specific Integrated Circuit). Alternatively (or in addition) the processor 512, in conjunction with one or more of the other components 530, 532, 534, 550, 570, 572, 335 and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etc.) configured to perform the functions of processors 512.

As described herein, the modem 520 may include hardware and software components for implementing the above features for unified TCI configuration and default beam selection (e.g., identification and/or determination) for multi-beam indication, e.g., in 5G NR systems and beyond, as well as the various other techniques described herein. The processors 522 may be configured to implement part or all of the features described herein, e.g., by executing program instructions stored on a memory medium (e.g., a non-transitory computer-readable memory medium). Alternatively (or in addition), processor 522 may be configured as a programmable hardware element, such as an FPGA (Field Programmable Gate Array), or as an ASIC (Application Specific Integrated Circuit). Alternatively (or in addition) the processor 522, in conjunction with one or more of the other components 540, 542, 544, 550, 570, 572, 335 and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etc.) configured to perform the functions of processors 522.

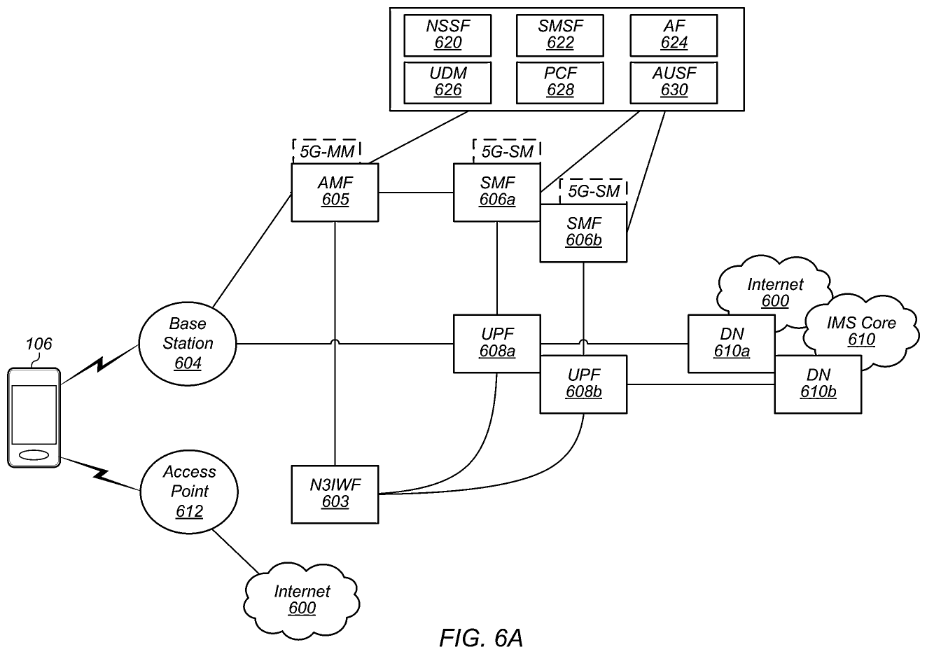

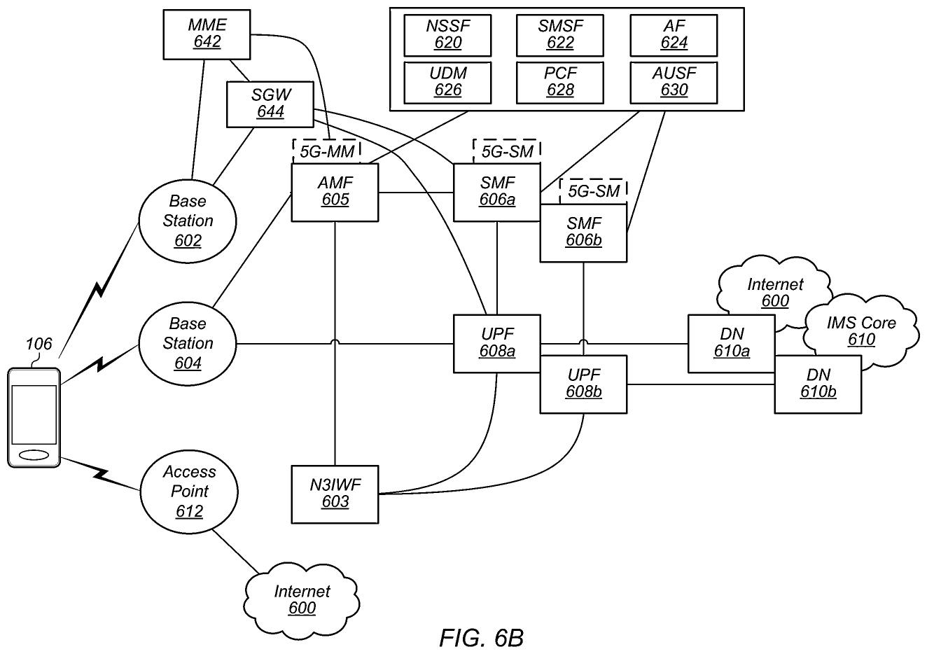

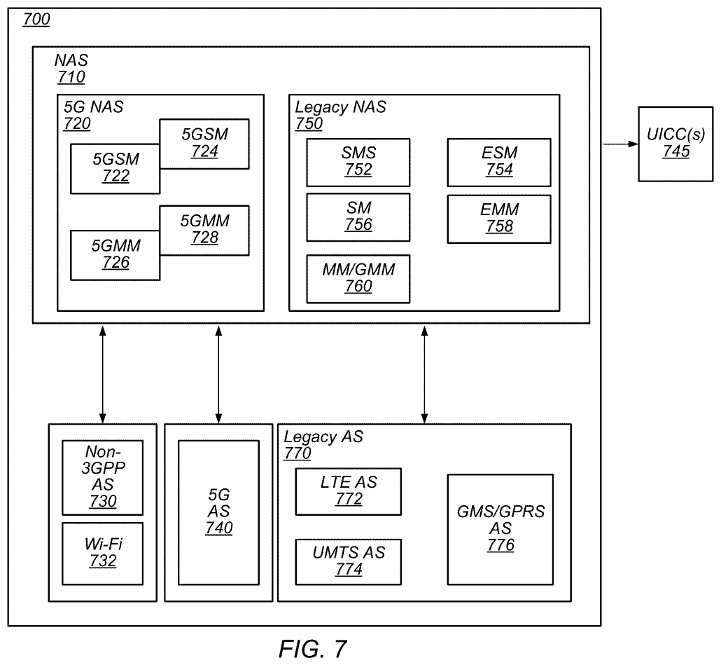

FIGS. 6A, 6B and 7: 5G Core Network Architecture-Interworking with Wi-Fi

In some embodiments, the 5G core network (CN) may be accessed via (or through) a cellular connection/interface (e.g., via a 3GPP communication architecture/protocol) and a non-cellular connection/interface (e.g., a non-3GPP access architecture/protocol such as Wi-Fi connection). FIG. 6A illustrates an example of a 5G network architecture that incorporates both 3GPP (e.g., cellular) and non-3GPP (e.g., non-cellular) access to the 5G CN, according to some embodiments. As shown, a user equipment device (e.g., such as UE 106) may access the 5G CN through both a radio access network (RAN, e.g., such as gNB 604, which may be a base station 102) and an access point, such as AP 612. The AP 612 may include a connection to the Internet 600 as well as a connection to a non-3GPP inter-working function (N3IWF) 603 network entity. The N3IWF may include a connection to a core access and mobility management function (AMF) 605 of the 5G CN. The AMF 605 may include an instance of a 5G mobility management (5G MM) function associated with the UE 106. In addition, the RAN (e.g., gNB 604) may also have a connection to the AMF 605. Thus, the 5G CN may support unified authentication over both connections as well as allow simultaneous registration for UE 106 access via both gNB 604 and AP 612. As shown, the AMF 605 may include one or more functional entities associated with the 5G CN (e.g., network slice selection function (NSSF) 620, short message service function (SMSF) 622, application function (AF) 624, unified data management (UDM) 626, policy control function (PCF) 628, and/or authentication server function (AUSF) 630). Note that these functional entities may also be supported by a session management function (SMF) 606a and an SMF 606b of the 5G CN. The AMF 605 may be connected to (or in communication with) the SMF 606a. Further, the gNB 604 may in communication with (or connected to) a user plane function (UPF) 608a that may also be communication with the SMF 606a. Similarly, the N3IWF 603 may be communicating with a UPF 608b that may also be communicating with the SMF 606b. Both UPFs may be communicating with the data network (e.g., DN 610a and 610b) and/or the Internet 600 and Internet Protocol (IP) Multimedia Subsystem/IP Multimedia Core Network Subsystem (IMS) core network 610.

FIG. 6B illustrates an example of a 5G network architecture that incorporates both dual 3GPP (e.g., LTE and 5G NR) access and non-3GPP access to the 5G CN, according to some embodiments. As shown, a user equipment device (e.g., such as UE 106) may access the 5G CN through both a radio access network (RAN, e.g., such as gNB 604 or eNB 602, which may be a base station 102) and an access point, such as AP 612. The AP 612 may include a connection to the Internet 600 as well as a connection to the N3IWF 603 network entity. The N3IWF may include a connection to the AMF 605 of the 5G CN. The AMF 605 may include an instance of the 5G MM function associated with the UE 106. In addition, the RAN (e.g., gNB 604) may also have a connection to the AMF 605. Thus, the 5G CN may support unified authentication over both connections as well as allow simultaneous registration for UE 106 access via both gNB 604 and AP 612. In addition, the 5G CN may support dual-registration of the UE on both a legacy network (e.g., LTE via eNB 602) and a 5G network (e.g., via gNB 604). As shown, the eNB 602 may have connections to a mobility management entity (MME) 642 and a serving gateway (SGW) 644. The MME 642 may have connections to both the SGW 644 and the AMF 605. In addition, the SGW 644 may have connections to both the SMF 606a and the UPF 608a. As shown, the AMF 605 may include one or more functional entities associated with the 5G CN (e.g., NSSF 620, SMSF 622, AF 624, UDM 626, PCF 628, and/or AUSF 630). Note that UDM 626 may also include a home subscriber server (HSS) function and the PCF may also include a policy and charging rules function (PCRF). Note further that these functional entities may also be supported by the SMF 606a and the SMF 606b of the 5G CN. The AMF 606 may be connected to (or in communication with) the SMF 606a. Further, the gNB 604 may in communication with (or connected to) the UPF 608a that may also be communication with the SMF 606a. Similarly, the N3IWF 603 may be communicating with a UPF 608b that may also be communicating with the SMF 606b. Both UPFs may be communicating with the data network (e.g., DN 610a and 610b) and/or the Internet 600 and IMS core network 610.

Note that in various embodiments, one or more of the above-described network entities may be configured to perform methods for unified TCI configuration and default beam selection (e.g., identification and/or determination) for multi-beam indication, e.g., in 5G NR systems and beyond, e.g., as further described herein.

FIG. 7 illustrates an example of a baseband processor architecture for a UE (e.g., such as UE 106), according to some embodiments. The baseband processor architecture 700 described in FIG. 7 may be implemented on one or more radios (e.g., radios 429 and/or 430 described above) or modems (e.g., modems 510 and/or 520) as described above. As shown, the non-access stratum (NAS) 710 may include a 5G NAS 720 and a legacy NAS 750. The legacy NAS 750 may include a communication connection with a legacy access stratum (AS) 770. The 5G NAS 720 may include communication connections with both a 5G AS 740 and a non-3GPP AS 730 and Wi-Fi AS 732. The 5G NAS 720 may include functional entities associated with both access stratums. Thus, the 5G NAS 720 may include multiple 5G MM entities 726 and 728 and 5G session management (SM) entities 722 and 724. The legacy NAS 750 may include functional entities such as short message service (SMS) entity 752, evolved packet system (EPS) session management (ESM) entity 754, session management (SM) entity 756, EPS mobility management (EMM) entity 758, and mobility management (MM)/GPRS mobility management (GMM) entity 760. In addition, the legacy AS 770 may include functional entities such as LTE AS 772, UMTS AS 774, and/or GSM/GPRS AS 776.

Thus, the baseband processor architecture 700 allows for a common 5G-NAS for both 5G cellular and non-cellular (e.g., non-3GPP access). Note that as shown, the 5G MM may maintain individual connection management and registration management state machines for each connection. Additionally, a device (e.g., UE 106) may register to a single PLMN (e.g., 5G CN) using 5G cellular access as well as non-cellular access. Further, it may be possible for the device to be in a connected state in one access and an idle state in another access and vice versa. Finally, there may be common 5G-MM procedures (e.g., registration, de-registration, identification, authentication, as so forth) for both accesses.

Note that in various embodiments, one or more of the above-described functional entities of the 5G NAS and/or 5G AS may be configured to perform methods for unified TCI configuration and default beam selection (e.g., identification and/or determination) for multi-beam indication, e.g., in 5G NR systems and beyond, e.g., as further described herein.

### Unified TCI Configuration for Multi-beam Indication

In 3GPP Release 17 of 5G NR, a unified transmission configuration indicator (TCI) state based beam indication framework was introduced. The unified TCI state based beam indication framework included two modes-joint TCI indication (Mode 1) and separate TCI indication (Mode 2). In Mode 1, a base station (e.g., a gNB) may provide a joint TCI state to indicate a downlink reference signal for beam indication for both uplink (UL) and downlink (DL) channels by a medium access control (MAC) control element (CE), a downlink configuration indicator (DCI) format 1_1, and/or a DCI format 1_2. In Mode 2, a base station (e.g., a gNB) may provide a DL TCI and/or an UL TCI for beam indication for DL channels and/or for UL channels by a MAC CE, a DCI format 1_1, and/or a DCI format 1_2. Further, the indicated TCI identifier (ID) may be applied for multiple channels within a serving cell or across multiple serving cells. Note that the target applied serving cell list can be configured by higher layer signaling (e.g., such as radio resource control (RRC) signaling). Additionally, TCI state list sharing across serving cells may be supported and a base station may optionally configure a TCI state list by RRC signaling for one bandwidth part (BWP) in a serving cell. Note that a TCI state may include parameters for configuring a quasi co-location (QCL) relationship between one or more downlink reference signals and demodulated reference signal (DMRS) ports of a PDSCH, the DM-RS port of PDCCH, and/or Channel State Information (CSI) reference signal (CSI-RS) port(s) of a CSI-RS resource. Note further that when a TCI state list is not configured, the TCI state list in a reference BWP in a serving cell may be applied. However, the unified TCI framework as defined in 3GPP Release 17 5G NR cannot support multiple transmission-reception point (multi-TRP) operation since the base station can only indicate one beam for one serving cell and multi-TRP operation requires at least two beams.

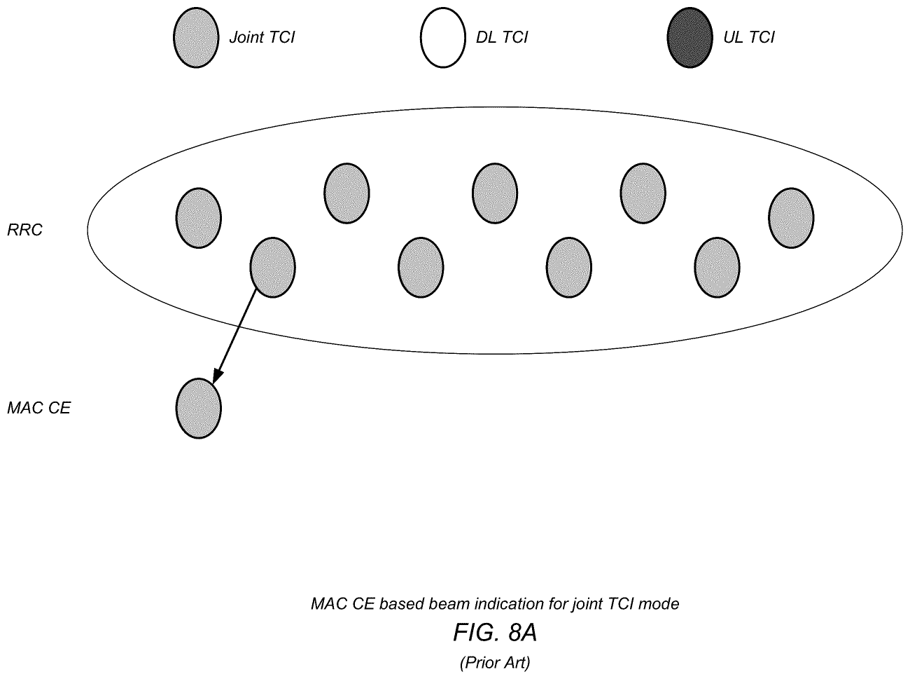

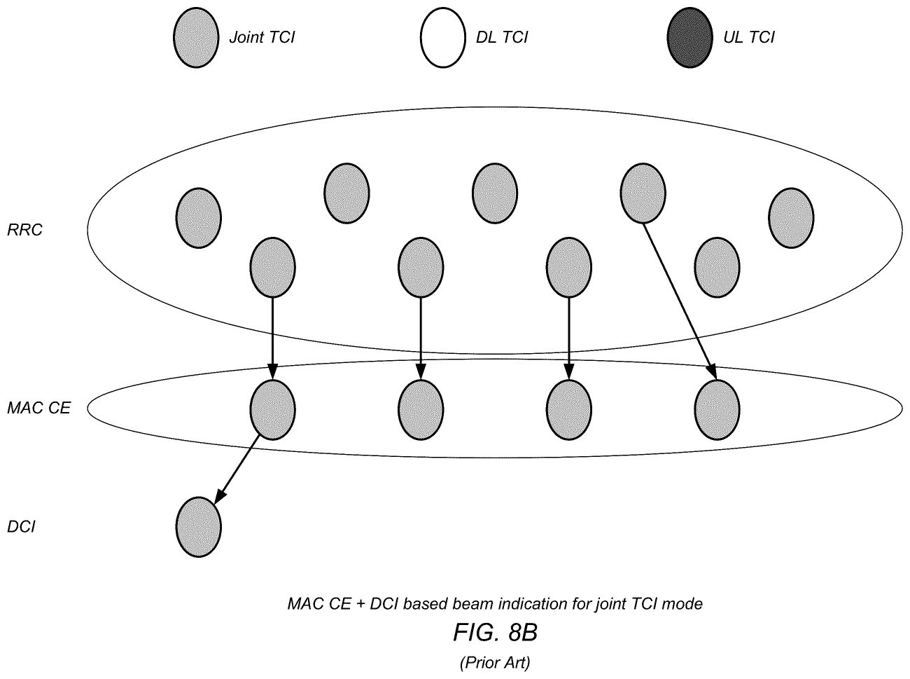

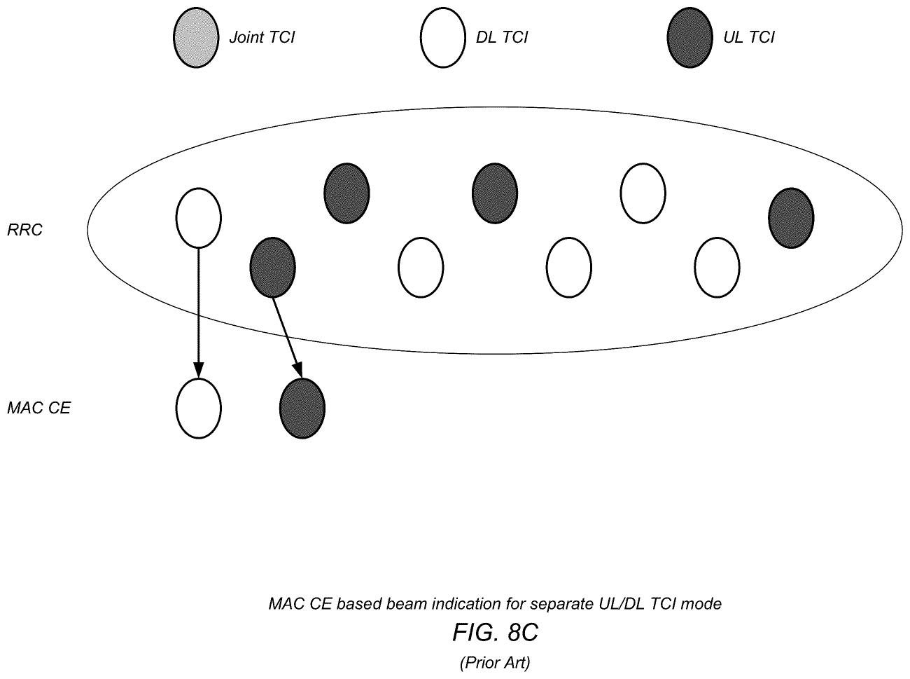

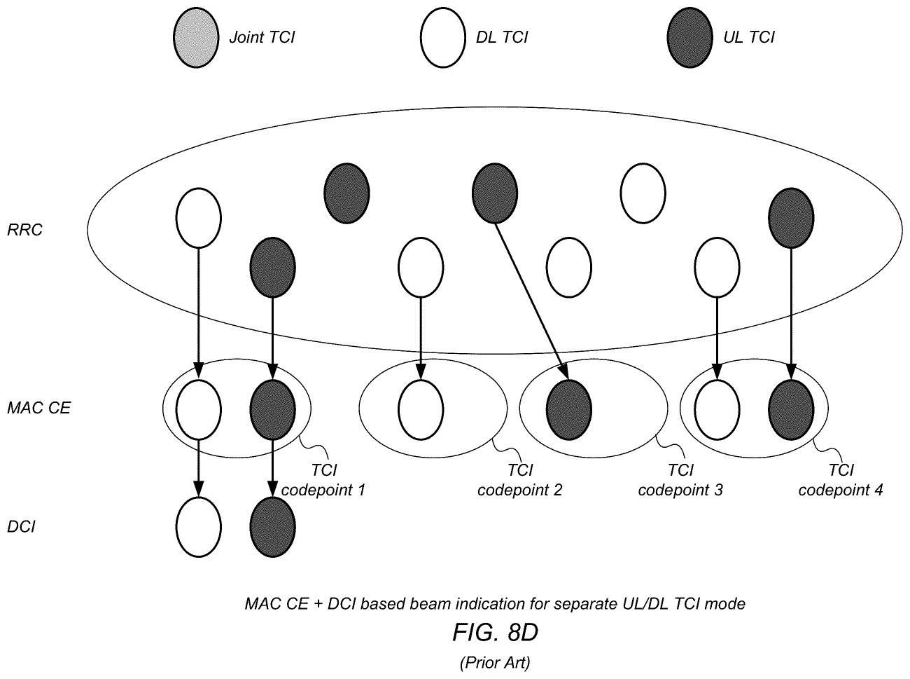

For example, FIGS. 8A, 8B, 8C, and 8D illustrate examples of the unified TCI state based beam indication framework. As shown, in FIG. 8A, a MAC CE may be used for a beam indication for a joint TCI mode selected from a set of joint TCI modes configured via RRC signaling. As shown in FIG. 8B, a DCI may be used for a beam indication for a joint TCI mode selected from a set of joint TCI modes indicated via a MAC CE. The set of joint TCI modes indicated via the MAC CE may be selected from a set of joint TCI modes configured via RRC signaling. As another example, as shown in FIG. 8C, a MACE CE may be used for a beam indication for separate UL/DL TCI modes selected from a set of UL/DL TCI modes configured via RRC signaling. Additionally, as shown in FIG. 8D, a DCI may be used for a beam indication for separate UL/DL TCI modes selected from a set of joint TCI modes (e.g., such as TCI codepoints 1, 2, 3, or 4) indicated via a MAC CE. The set of joint TCI modes indicated via the MAC CE may be selected from a set of joint TCI modes configured via RRC signaling.

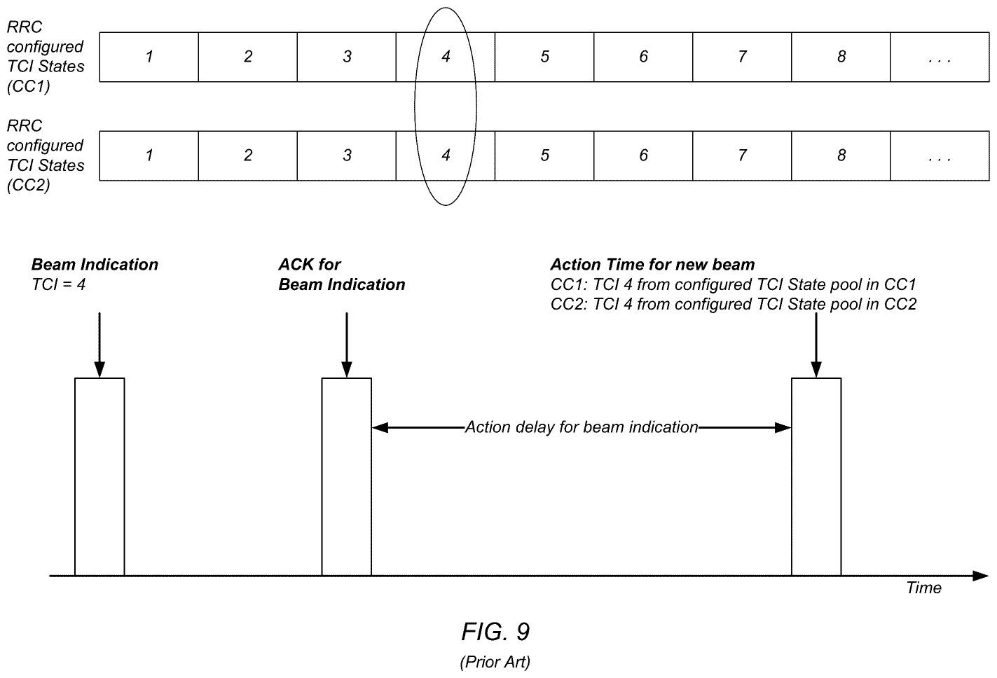

In addition, FIG. 9 illustrates an example of common TCI ID indication for multiple component carriers (CCs). As shown, RRC signaling may be used to configured various TCI states for a first CC (e.g., CC1) and a second CC (e.g., CC2). Then, a beam indication, e.g., such as a MAC CE or a DCI, may be used to indicate TCI state 4 (e.g., TCI ID is 4) for both the first CC and the second CC. A UE may then send an acknowledgement for the beam indication prior to switching to the new beam (e.g., action time for new beam) indicated by the TCI state. Note that there may be a delay between the acknowledgment and the switch to/activation of the new beam, as shown.

Therefore, improvements are need to extend the unified TCI framework to support multi-beam indication and further, multi-TRP operation. For example, current issues include how to support cross-cell TCI state list sharing and common TCI ID indication with regard to different multi-TRP operation in different serving cells as well as determination of which TCI to use to buffer data when a scheduling offset is below a threshold when multiple TCI states are indicated (e.g., which TCI state is a default TCI state).

Embodiments described herein provide systems, methods, and mechanisms for unified TCI configuration and default beam indication (e.g., selection, identification, and/or determination) for multi-beam indication, including systems, methods, and mechanisms for supporting cross-cell TCI state list sharing and common TCI ID indication with regard to different multi-TRP operation in different serving cells as well as for determining which TCI to use to buffer data when a scheduling offset is below a threshold when multiple TCI states are indicated (e.g., which TCI state is a default TCI state).

In some instances, multi-TRP operation from different serving cells may be different. For example, some serving cells may be configured with single TRP (sTRP) operation. As another example, some serving cells may be configured with single-DCI (sDCI) based multi-TRP (mTRP) operation. As a further example, some serving cells may be configured with multi-DCI (mDCI) based mTRP operation, where different control resource set (CORESET) pool indexes (CorsetPoolIndex) may be provided in different CORESETs. Further, TRP(s) for different serving cells may be the same or may be different.

As an example, in some instances, for cross-cell TCI state list sharing, with regard to different sTRP/mTRP configurations in different serving cells, a TCI state list may be configured at a per-TRP level. In addition, if a TCI state list in one TRP is not configured, a base station may indicate a reference bandwidth part (BWP), component carrier (CC), or TRP index to a UE to identify a default TCI state list for each TRP, e.g., as shown in Table 1.

TABLE 1

| | TCI state list | TCI state list | TCI state list | Operation |
|---|---|---|---|---|
| | for TRP 1 | for TRP 2 | for TRP 3 | Mode |
| Serving | Configured | Configured | Not | mTRP |
| Cell 1 | | | configured | operation |
| | | | | from TRP 1 |
| | | | | and TRP 2 |
| Serving | Reference CC | Not | Not | sTRP operation |
| Cell 2 | is Serving Cell | configured | configured | from TRP 1 |
| | 1; Reference | | | |
| | TRP is TRP 1 | | | |
| Serving | | Reference CC | Configured | mTRP |
| Cell 3 | | is Serving Cell | | operation |
| | | 1; Reference | | from TRP 2 |
| | | TRP is TRP 2 | | and TRP 3 |

Thus, as shown by Table 1, for a first serving cell (e.g., serving cell 1), a UE, such as UE 106, may have a TCI state list for a first TRP (e.g., TRP 1) configured (e.g., by a base station, such as base station 102) and a TCI state list for a second TRP (e.g., TRP 2) configured. However, a TCI state list for a third TRP (e.g., TRP 3) may not be configured for the UE. Thus, the UE may determine that an operation mode of the serving cell 1 may be mTRP operation from TRP1 and TRP 2, e.g., as indicated be the configured TRP state lists. Further, for a second serving cell (e.g., serving cell 2), the UE may receive an indication from the base station for a reference BWP/CC/TRP index to determine (or identify) a default TCI state list for TRP 1, e.g., an indication that a reference component carrier is serving cell 1 and a reference TRP is TRP 1. Additionally, TCI state lists for TRP 2 and TRP 3 may not be configured for the UE. Thus, the UE may determine that an operation mode of the serving cell 2 may be sTRP operation from TRP 1, e.g., as indicated by the TCI state list for TRP 1. In addition, a third serving cell (e.g., serving cell 3), the UE may not have a TCI state list for TRP 1 or an indication from the base station for a reference BWP/CC/TRP index. Further, the UE may receive an indication from the base station for a reference BWP/CC/TRP index to determine (or identify) a default TCI state list for TRP 2, e.g., an indication that a reference component carrier is serving cell 1 and a reference TRP 2. Additionally, the UE may have a TCI state list for TRP 3 configured. Thus, the UE may determine that an operation mode of the serving cell 3 may be mTRP operation from TRP 2 and TRP 3, e.g., as indicated by the TRP state lists.

As another example, in some instances, for cross-cell TCI state list sharing, with regard to different sTRP/mTRP configurations in different serving cells, a single TCI state list may be configured for mTRP operation. A base station may then (optionally) indicate a reference BWP or CC to identify an additional TCI state list or additional TCI state lists for mTRP operation. Additionally, a reference BWP or CC index may be provided by the base station to a UE via radio resource control (RRC) signaling or determined by the UE based on BWP index and/or CC index (e.g., a lowest index is the reference BWP or CC) within the serving cell list for TCI state list sharing, for example, as shown in Table 2.

TABLE 2

| | | Additional | |
|---|---|---|---|
| | TCI state list | TCI state list | Operation Mode |
| Serving Cell 1 | Configured | Not Configured | sTRP operation |
| Serving Cell 2 | Not | Reference CC | sTRP operation |
| | configured | is Serving | |
| | | Cell 1 | |
| Serving Cell 3 | Configured | Reference CC | mTRP operation based |
| | | is Serving | on TCI state list |
| | | Cell 1 | from Serving cells |
| | | | 1 and 3 |

Thus, as shown in Table 2, for a first serving cell (e.g., serving cell 1), a UE, such as UE 106, may have a TCI state list configured by a base station, such as base station 102, but not an additional TCI state list. The UE may then determine that an operation mode of the serving cell 1 may be sTRP operation. Additionally, for a second serving cell (e.g., serving cell 2), the UE may not have a TCI state list configured but may receive an indication from the base station for a reference BWP/CC to determine (or identify) an additional TCI state list, e.g., an indication that a reference component carrier is serving cell 1. The UE may then determine that an operation mode of the serving cell 2 may be sTRP operation. In addition, for a third serving cell (e.g., serving cell 3), the UE may have a TCI state list configured and may receive an indication from the base station for a reference BWP/CC to determine (or identify) an additional TCI state list, e.g., an indication that a reference component carrier is serving cell 1. The UE may then determine that an operation mode of the serving cell 3 may be mTRP operation based on the TCI state list from serving cell 1 and serving cell 3.

As a further example, in some instances, for cross-cell TCI state list sharing, with regard to different sTRP/mTRP configurations in different serving cells, a TCI state list sharing may only be applied for serving cells with the same sTRP/mTRP configurations. For example, for mDCI based mTRP operation, a TRP and CORESET pool index may be one-to-one mapped.

In some instances, for a multi-CC common TCI ID indication, with regards to different STRP/mTRP configurations, if a single TCI is indicated in a serving cell with sTRP or sDCI based mTRP operation, a base station, such as base station 102, may indicate a TRP index to identify the target applicable channels to a UE, such as UE 106. Note that a serving cell with an sTRP configuration may always apply the indicated TCI. Additionally, a first candidate value of the TRP index may indicate “not applicable for mTRP serving cell” and a second candidate value of the TRP index may indicate “applicable for both TRPs for mTRP serving cell”, e.g., to support dynamic switching between sTRP and mTRP operation. In some instances, the TRP index may be provided by a MAC CE for TCI activation or a DCI for TCI indication.

In some instances, for a multi-CC common TCI ID indication, with regards to different STRP/mTRP configurations, if a single TCI is indicated in a serving cell with mDCI based mTRP operation, whether the single TCI is to be applied for a serving cell with sTRP or sDCI based mTRP operation can be predefined or indicated (e.g., to a UE, such as UE 106) by a base station, such as base station 102. Note that if this is applied for a serving cell with sDCI based mTRP operation, the base station may indicate a target TRP index to a UE. Additionally, a first candidate value of the TRP index may indicate “applicable for both TRPs for mTRP serving cell” to support dynamic switching between sTRP and mTRP operation. In some instances, the TRP index may be provided by a MAC CE for TCI activation or a DCI for TCI indication.

In some instances, for a multi-CC common TCI ID indication, with regards to different STRP/mTRP configurations, if multiple TCI states are indicated in a serving cell, whether the TCI states are applicable for serving cells with sTRP operation can be predefined or indicated by a base station, such as base station 102, to a UE, such as UE 106. For example, a first/last TCI state may be applied for the serving cell with sTRP operation. As another example, a TCI state with a lowest and/or highest index may be applied for a serving cell with sTRP operation. As a further example, a TCI state with the same TRP index for the TCI state list may be applied for the serving cell with sTRP operation. As a yet further example, which TCI is to be applied to the serving cell with sTRP operation may be explicitly indicated by the base station to the UE. Note that in addition, a corresponding case, e.g., which means the CC list for a common TCI index indication, may only be configured for CCs without the corresponding case.

In some instances, when multiple TCI states are provided, a default beam to buffer downlink data, e.g., to receive aperiodic CSI-RS or PDSCH with scheduling offset smaller than a threshold reported by UE capability, may be based on common TCI states for a serving cell as indicated by a MAC CE or DCI. Note that if a UE, such as UE 106, does not support simultaneous reception of multiple beams, e.g., only time-division multiplexed (TDMed) based mTRP operation is enabled, the UE may choose one of the indicated TCI states to buffer downlink data. For example, the UE may select a first or last TCI state. As another example, the UE may select a TCI state with a lowest or highest index. As a further example, which TCI state is to be selected by the UE may be indicated by a base station. As a yet further example, which TCI state is applied may be determined by a sub-slot, slot, subframe, and/or frame index. Note further that if the UE supports simultaneous reception of multiple beams, the UE may apply the indicated TCI states to buffer data. Additionally, if a quasi-collocated TypeD (QCL-TypeD) (e.g., spatial receive parameter) assumption for the indicated TCI states for multiple serving cells within a band or band group is different, the UE may choose and/or select the TCI states with higher priority to buffer data across cells. In some instances, priority may be determined by a type of cell, e.g., a primary cell is higher priority than a secondary cell and/or STRP/mTRP operation, e.g., sTRP is higher priority than mTRP, and/or a serving cell index (e.g., lower index is higher priority than higher index). In some instances, when multiple TCI states are provided, a default beam to buffer downlink data, e.g., to receive aperiodic CSI-RS or PDSCH with scheduling offset smaller than a threshold reported by UE capability, may be based on QCL/TCI states for CORESETs in a latest slot. Note that the identified QCL/TCI states may be used to buffer downlink data across serving cells in a band. Note further, that if there are other known signals, e.g., semi-persistent/periodic CSI-RS, aperiodic CSI-RS/PDSCH with scheduling offset larger than a threshold, and so forth, in one serving cell, a QCL assumption for that serving cell may be used to buffer data. Further, if the UE supports simultaneous multi-beam reception, the UE may use the same criteria to identify a second default beam. In addition, the identified second default beam and the known signals may be from different TRPs.

In some instances, when multiple TCI states are provided, a UE, such as UE 106, may identify and/or determine a default beam to buffer downlink data, e.g., to receive aperiodic CSI-RS or PDSCH with scheduling offset smaller than a threshold reported by UE capability, by identifying one or two QCL/TCI states to receive CORESETs in a band in the latest slot, subject to UE capability and RRC configuration. Note that the identification for the QCL/TCI states may be based on configuration and priority for the CORESETs and associated search space (SSs). Thus, if a UE is configured for single cell operation or for operation with carrier aggregation in a same frequency band, the UE may monitor PDCCH candidates in overlapping PDCCH monitoring occasions in multiple CORESETs that have been configured with a same or different QCL-Type set to ‘typeD’ properties on active DL BWP(s) of one or more cells. Additionally, if the UE is provided a two-QCLTypeDforPDCCHRepetition parameter, the UE may monitor PDCCHs only in a first CORESET with QCL-Type set to first ‘typeD’ properties and, if any, in a second CORESET with qcl-Type set to second ‘typeD’ properties that are different than the first ‘typeD’ properties, and in any other CORESET from the multiple CORESETs with corresponding qcl-Type set to the first ‘typeD’ properties and/or to the second ‘typeD’ properties. The first CORESET corresponds to the CSS set with the lowest index in the cell with the lowest index containing CSS sets, if any; otherwise, to a UE specific search space (USS) set with the lowest index in the cell with lowest index excluding CSS sets and USS sets associated with CORESETs with qcl-Type set to first ‘typeD’ properties, the second CORESET corresponds to the CSS set with the lowest index in the cell with the lowest index containing CSS sets; if any; otherwise, to the USS set with the lowest index in the cell with lowest index, where the CSS set or the USS set includes searchSpaceLinking with a value indicating, respectively, any CSS set or any USS set associated with CORESETs with qcl-Type set to first ‘typeD’ properties. The lowest USS set index is determined over all USS sets with at least one PDCCH candidate in overlapping PDCCH monitoring occasions. Further, if a UE is configured for single cell operation or for operation with carrier aggregation in a same frequency band, monitors PDCCH candidates in overlapping PDCCH monitoring occasions in multiple CORESETs that have been configured with same or different qcl-Type set to ‘typeD’ properties on active DL BWP(s) of one or more cells, one or more CORESETs have two activated TCI states, and the UE reports it supports two QCL-TypeD, then the UE monitors PDCCHs only in a CORESET with a first qcl-Type set to first ‘typeD’ properties and, if any, a second qcl-Type set to second ‘typeD’ properties that are different than the first ‘typeD’ properties, and in any other CORESET from the multiple CORESETs with corresponding qcl-Type set to the first ‘typeD’ properties or to the second ‘typeD’ properties. The CORESET corresponds to the CSS set with the lowest index in the cell with the lowest index containing CSS, if any; otherwise, to the USS set with the lowest index in the cell with lowest index. The lowest USS set index is determined over all USS sets with at least one PDCCH candidate in overlapping PDCCH monitoring occasions.

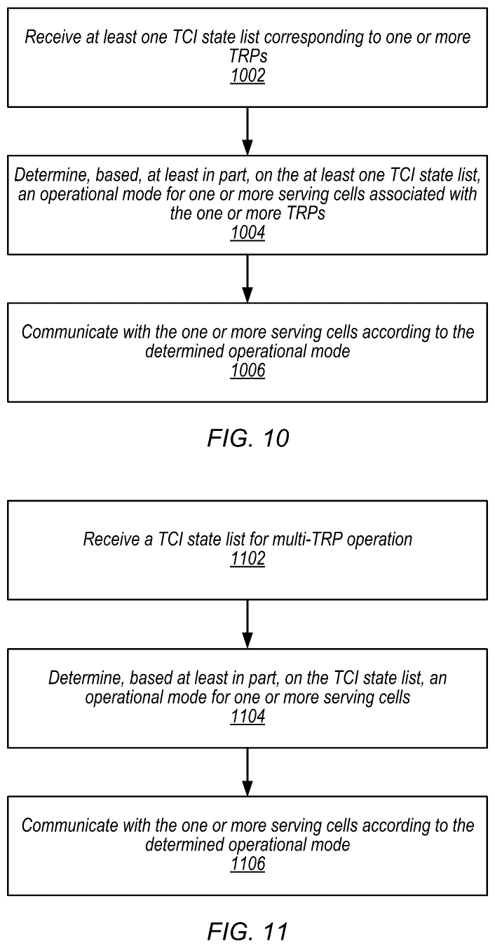

FIG. 10 illustrates a block diagram of an example of a method for supporting a multi-beam indication, according to some embodiments. The method shown in FIG. 10 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 1002, a UE, such as UE 106, may receive, from a base station, such as base station 102, at least one transmission configuration indicator (TCI) state list corresponding to one or more transmission-reception points (TRPs).

At 1004, the UE may determine, based, at least in part, on the at least one TCI state list, an operational mode for one or more serving cells associated with the one or more TRPs.

At 1006, the UE may communicate with the one or more serving cells according to the determined operational mode.

In some instances, when a TCI state list is not configured for a serving cell of the one or more serving cells, the UE may receive, from the base station, an indication of at least one of a reference bandwidth part, a reference component carrier, or a reference TRP for the serving cell.

In some instances, the UE may receive, from the base station, an indication of at least one of a reference bandwidth part or reference component carrier for a serving cell of the one or more serving cells. The indication may identify an additional TCI state list for multi-TRP operation. In some instances, the indication may be received via radio resource control signaling.

In some instances, the UE may receive, from the base station, an indication of a TCI state list including a plurality of TCI states for a serving cell of the one or more serving cells and may determine which of the plurality of TCI states in the TCI state list is applicable for the serving cell for single TRP operation. In some instances, the determination may be made by (e.g., based, at least in part, on) applying a first TCI state in the list of TCI states for the serving cell for single TRP operation, applying a last TCI state in the list of TCI states for the serving cell for single TRP operation, applying a TCI state with a lowest TCI index in the list of TCI states for the serving cell for single TRP operation, applying a TCI state with a highest TCI index in the list of TCI states for the serving cell for single TRP operation, and/or applying a TCI state as indicated by the base station for the serving cell for single TRP operation.

In some instances, when the at least one TCI state list includes a plurality of TCI states, the UE may determine a default beam to buffer downlink data to receive an aperiodic Channel State Information (CSI) reference signal (CSI-RS) or a physical downlink shared channel with a scheduling offset less than a threshold based, at least in part, on common TCI states included in a TCI state list for a serving cell indicated in one of a medium access control (MAC) control element (CE) or downlink control information (DCI) received from the base station. The threshold may be reported by UE capability. In some instances, when the UE does not support simultaneous reception of multiple beams, the UE may select a TCI state from the common TCI states to buffer downlink data by (e.g., based, at least in part, on) selecting a first TCI state in the list of TCI states, selecting a last TCI state in the list of TCI states, selecting a TCI state in the TCI state list as indicated by the base station, and/or selecting a TCI state in the TCI state list based on one of a sub-slot index, slot index, subframe index, or frame index. In some instances, when the UE does support simultaneous reception of multiple beams, the UE may select the common TCI states to buffer downlink data. Additionally, in some instances, when a spatial receive parameter assumption for indicated TCI states for multiple serving cells within a band or band group are different, the UE may select TCI states to buffer downlink data across the multiple serving cells based on priority of a serving cell within the multiple serving cells. The priority may be based, at least in part, on at least one of cell type, cell TRP operation, and/or cell index. Note that when the priority is based on cell type, a primary serving cell within the multiple serving cells may have a higher priority than a secondary serving cell within the multiple serving cells. Note additionally that when the priority is based on cell TRP operation, a serving cell within the multiple serving cells operating as a single TRP may have a higher priority than a serving cell within the multiple serving cells operating as a multiple TRP. Note further that when the priority is based on cell index, a serving cell within the multiple serving cells with a lower index may have a higher priority than a serving cell within the multiple serving cells with a higher index. In some instances, when at least one of a semi-persistent CSI-RS, periodic CSI-RS, aperiodic CSI-RS, or PDSCH has a scheduling offset larger than the threshold in a serving cell, the UE may buffer data based, at least in part, on a spatial relation (e.g., QCL) assumption for the serving cell. In some instances, when the UE supports simultaneous multi-beam reception, the UE may determine a second default beam to buffer downlink data based, at least in part, on at least one of common TCI states included in a TCI state list for a serving cell indicated in one of a MAC CE received from the base station, a DCI received from the base station, a QCL assumption for CORESETs in a most recent slot or TCI states for CORESETs in a most recent slot.

In some instances, the UE may determine a default beam to buffer downlink data to receive an aperiodic Channel State Information (CSI) reference signal (CSI-RS) or a physical downlink shared channel with a scheduling offset less than a threshold based on at least one of quasi-co-location (QCL) assumption or TCI states for Control Resource Sets (CORESETs) in a most recent slot. The threshold may be reported by UE capability. In some instances, determining the default beam to buffer downlink data may include the UE identifying at least one of the QCL assumption or the TCI states based on configuration and priority for the CORESETs and associated search spaces (SSs). The priority may be based, at least in part, on section 10.1 of 3GPP technical specification 38.213. In some instances, the UE may buffer downlink data across serving cells in a band based on the determined QCL information or TCI states. In some instances, when at least one of a semi-persistent CSI-RS, periodic CSI-RS, aperiodic CSI-RS, or PDSCH has a scheduling offset larger than the threshold in a serving cell, the UE may buffer data based, at least in part, on a spatial relation (e.g., QCL) assumption for the serving cell. In some instances, when the UE supports simultaneous multi-beam reception, the UE may determine a second default beam to buffer downlink data based, at least in part, on at least one of common TCI states included in a TCI state list for a serving cell indicated in one of a MAC CE received from the base station, a DCI received from the base station, a QCL assumption for CORESETs in a most recent slot or TCI states for CORESETs in a most recent slot.

FIG. 11 illustrates a block diagram of another example of a method for supporting a multi-beam indication, according to some embodiments. The method shown in FIG. 11 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 1102, a UE, such as UE 106, may receive, from a base station, such as base station 102, a TCI state list for multi-TRP operation.

At 1104, the UE may determine, based, at least in part, on the TCI state list, an operational mode for one or more serving cells associated with the TCI state list; and

At 1106, the UE may communicate with the one or more serving cells according to the determined operational mode.

In some instances, the UE may receive, from the base station, an indication of at least one of a reference bandwidth part or reference component carrier for a serving cell of the one or more serving cells. The indication may identify an additional TCI state list for multi-TRP operation. In some instances, the indication may be received via radio resource control signaling.

In some instances, the UE may receive, from the base station, an indication of a TCI state list including a plurality of TCI states for a serving cell of the one or more serving cells and may determine which of the plurality of TCI states in the TCI state list is applicable for the serving cell for single TRP operation. In some instances, the determination may be made by (e.g., based, at least in part, on) applying a first TCI state in the list of TCI states for the serving cell for single TRP operation, applying a last TCI state in the list of TCI states for the serving cell for single TRP operation, applying a TCI state with a lowest TCI index in the list of TCI states for the serving cell for single TRP operation, applying a TCI state with a highest TCI index in the list of TCI states for the serving cell for single TRP operation, and/or applying a TCI state as indicated by the base station for the serving cell for single TRP operation.

In some instances, when the at least one TCI state list includes a plurality of TCI states, the UE may determine a default beam to buffer downlink data to receive an aperiodic Channel State Information (CSI) reference signal (CSI-RS) or a physical downlink shared channel with a scheduling offset less than a threshold based, at least in part, on common TCI states included in a TCI state list for a serving cell indicated in one of a medium access control (MAC) control element (CE) or downlink control information (DCI) received from the base station. The threshold may be reported by UE capability. In some instances, when the UE does not support simultaneous reception of multiple beams, the UE may select a TCI state from the common TCI states to buffer downlink data by (e.g., based, at least in part, on) selecting a first TCI state in the list of TCI states, selecting a last TCI state in the list of TCI states, selecting a TCI state in the TCI state list as indicated by the base station, and/or selecting a TCI state in the TCI state list based on one of a sub-slot index, slot index, subframe index, or frame index. In some instances, when the UE does support simultaneous reception of multiple beams, the UE may select the common TCI states to buffer downlink data. Additionally, in some instances, when a spatial receive parameter assumption for indicated TCI states for multiple serving cells within a band or band group are different, the UE may select TCI states to buffer downlink data across the multiple serving cells based on priority of a serving cell within the multiple serving cells. The priority may be based, at least in part, on at least one of cell type, cell TRP operation, and/or cell index. Note that when the priority is based on cell type, a primary serving cell within the multiple serving cells may have a higher priority than a secondary serving cell within the multiple serving cells. Note additionally that when the priority is based on cell TRP operation, a serving cell within the multiple serving cells operating as a single TRP may have a higher priority than a serving cell within the multiple serving cells operating as a multiple TRP. Note further that when the priority is based on cell index, a serving cell within the multiple serving cells with a lower index may have a higher priority than a serving cell within the multiple serving cells with a higher index. In some instances, when at least one of a semi-persistent CSI-RS, periodic CSI-RS, aperiodic CSI-RS, or PDSCH has a scheduling offset larger than the threshold in a serving cell, the UE may buffer data based, at least in part, on a spatial relation (e.g., QCL) assumption for the serving cell. In some instances, when the UE supports simultaneous multi-beam reception, the UE may determine a second default beam to buffer downlink data based, at least in part, on at least one of common TCI states included in a TCI state list for a serving cell indicated in one of a MAC CE received from the base station, a DCI received from the base station, a QCL assumption for CORESETs in a most recent slot or TCI states for CORESETs in a most recent slot.

In some instances, the UE may determine a default beam to buffer downlink data to receive an aperiodic Channel State Information (CSI) reference signal (CSI-RS) or a physical downlink shared channel with a scheduling offset less than a threshold based on at least one of quasi-co-location (QCL) assumption or TCI states for Control Resource Sets (CORESETs) in a most recent slot. The threshold may be reported by UE capability. In some instances, determining the default beam to buffer downlink data may include the UE identifying at least one of the QCL assumption or the TCI states based on configuration and priority for the CORESETs and associated search spaces (SSs). The priority may be based, at least in part, on section 11.1 of 3GPP technical specification 38.213. In some instances, the UE may buffer downlink data across serving cells in a band based on the determined QCL information or TCI states. In some instances, when at least one of a semi-persistent CSI-RS, periodic CSI-RS, aperiodic CSI-RS, or PDSCH has a scheduling offset larger than the threshold in a serving cell, the UE may buffer data based, at least in part, on a spatial relation (e.g., QCL) assumption for the serving cell. In some instances, when the UE supports simultaneous multi-beam reception, the UE may determine a second default beam to buffer downlink data based, at least in part, on at least one of common TCI states included in a TCI state list for a serving cell indicated in one of a MAC CE received from the base station, a DCI received from the base station, a QCL assumption for CORESETs in a most recent slot or TCI states for CORESETs in a most recent slot.

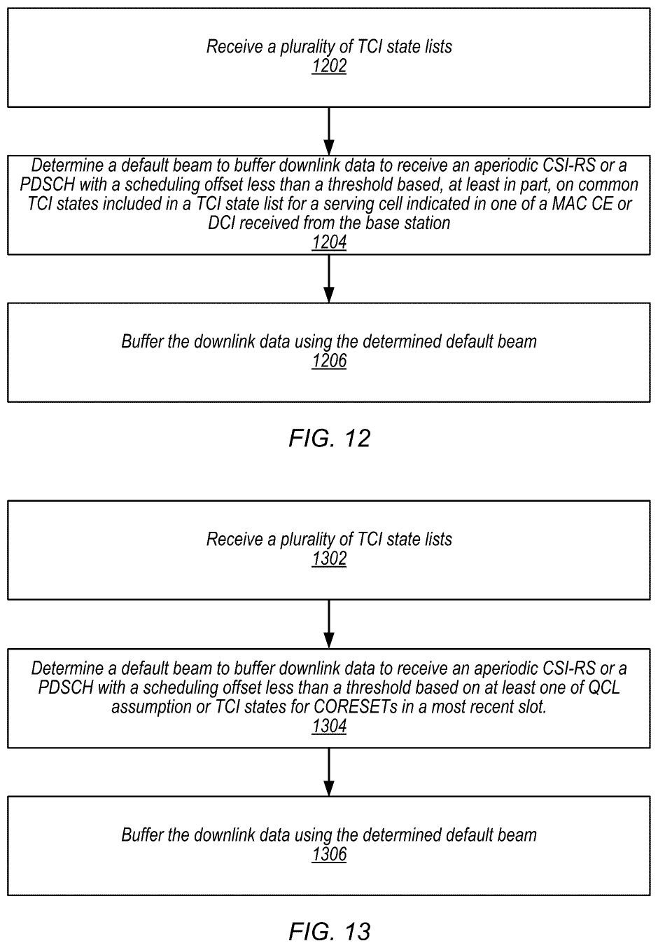

FIG. 12 illustrates a block diagram of an example of a method for determining a default beam to buffer downlink data, according to some embodiments. The method shown in FIG. 12 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 1202, a UE, such as UE 106, may receive, from a base station, such as base station 102, a plurality of transmission configuration indicator (TCI) state lists.

At 1204, the UE may determine a default beam to buffer downlink data to receive an aperiodic Channel State Information (CSI) reference signal (CSI-RS) or a physical downlink shared channel (PDSCH) with a scheduling offset less than a threshold based, at least in part, on common TCI states included in a TCI state list for a serving cell indicated in one of a medium access control (MAC) control element (CE) or downlink control information (DCI) received from the base station. The threshold may be reported by UE capability.

At 1206, the UE may buffer the downlink data using the determined default beam.

In some instances, when the UE does not support simultaneous reception of multiple beams, the UE may select a TCI state from the common TCI states to buffer downlink data by (e.g., based, at least in part, on) selecting a first TCI state in the list of TCI states, selecting a last TCI state in the list of TCI states, selecting a TCI state in the TCI state list as indicated by the base station, and/or selecting a TCI state in the TCI state list based on one of a sub-slot index, slot index, subframe index, or frame index. In some instances, when the UE does support simultaneous reception of multiple beams, the UE may select the common TCI states to buffer downlink data.

Additionally, in some instances, when a spatial receive parameter assumption for indicated TCI states for multiple serving cells within a band or band group are different, the UE may select TCI states to buffer downlink data across the multiple serving cells based on priority of a serving cell within the multiple serving cells. The priority may be based, at least in part, on at least one of cell type, cell TRP operation, and/or cell index. Note that when the priority is based on cell type, a primary serving cell within the multiple serving cells may have a higher priority than a secondary serving cell within the multiple serving cells. Note additionally that when the priority is based on cell TRP operation, a serving cell within the multiple serving cells operating as a single TRP may have a higher priority than a serving cell within the multiple serving cells operating as a multiple TRP. Note further that when the priority is based on cell index, a serving cell within the multiple serving cells with a lower index may have a higher priority than a serving cell within the multiple serving cells with a higher index.

In some instances, when at least one of a semi-persistent CSI-RS, periodic CSI-RS, aperiodic CSI-RS, or PDSCH has a scheduling offset larger than the threshold in a serving cell, the UE may buffer data based, at least in part, on a spatial relation (e.g., QCL) assumption for the serving cell. In some instances, when the UE supports simultaneous multi-beam reception, the UE may determine a second default beam to buffer downlink data based, at least in part, on at least one of common TCI states included in a TCI state list for a serving cell indicated in one of a MAC CE received from the base station, a DCI received from the base station, a QCL assumption for CORESETs in a most recent slot or TCI states for CORESETs in a most recent slot.

In some instances, the UE may determine, based, at least in part, on the TCI state list, an operational mode for one or more serving cells associated with one or more TRPs. Additionally, the UE may communicate with the one or more serving cells according to the determined operational mode. In some instances, when a TCI state list is not configured for a serving cell of the one or more serving cells, the UE may receive, from the base station, an indication of at least one of a reference bandwidth part, a reference component carrier, or a reference TRP for the serving cell. In some instances, the UE may receive, from the base station, an indication of at least one of a reference bandwidth part or reference component carrier for a serving cell of the one or more serving cells. The indication may identify an additional TCI state list for multi-TRP operation. In some instances, the indication may be received via radio resource control signaling.

In some instances, the UE may receive, from the base station, an indication of the TCI state list including a plurality of TCI states for a serving cell of the one or more serving cells and may determine which of the plurality of TCI states in the TCI state list is applicable for the serving cell for single TRP operation. In some instances, the determination may be made by (e.g., based, at least in part, on) applying a first TCI state in the list of TCI states for the serving cell for single TRP operation, applying a last TCI state in the list of TCI states for the serving cell for single TRP operation, applying a TCI state with a lowest TCI index in the list of TCI states for the serving cell for single TRP operation, applying a TCI state with a highest TCI index in the list of TCI states for the serving cell for single TRP operation, and/or applying a TCI state as indicated by the base station for the serving cell for single TRP operation.

FIG. 13 illustrates a block diagram of another example of a method for determining a default beam to buffer downlink data, according to some embodiments. The method shown in FIG. 13 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 1302, a UE, such as UE 106, may receive, from a base station, such as base station 102, a plurality of transmission configuration indicator (TCI) state lists.

At 1304, the UE may determine a default beam to buffer downlink data to receive an aperiodic Channel State Information (CSI) reference signal (CSI-RS) or a physical downlink shared channel (PDSCH) with a scheduling offset less than a threshold based on at least one of quasi-co-location (QCL) assumption or TCI states for Control Resource Sets (CORESETs) in a most recent slot. The threshold may be reported by UE capability. In some instances, determining the default beam to buffer downlink data may include the UE identifying at least one of the QCL assumption or the TCI states based on configuration and priority for the CORESETs and associated search spaces (SSs). The priority may be based, at least in part, on section 11.1 of 3GPP technical specification 38.213.

At 1306, the UE may buffer the downlink data using the determined default beam.

In some instances, the UE may buffer downlink data across serving cells in a band based on the determined QCL information or TCI states. In some instances, when at least one of a semi-persistent CSI-RS, periodic CSI-RS, aperiodic CSI-RS, or PDSCH has a scheduling offset larger than the threshold in a serving cell, the UE may buffer data based, at least in part, on a spatial relation (e.g., QCL) assumption for the serving cell. In some instances, when the UE supports simultaneous multi-beam reception, the UE may determine a second default beam to buffer downlink data based, at least in part, on at least one of common TCI states included in a TCI state list for a serving cell indicated in one of a MAC CE received from the base station, a DCI received from the base station, a QCL assumption for CORESETs in a most recent slot or TCI states for CORESETs in a most recent slot.

In some instances, when at least one of a semi-persistent CSI-RS, periodic CSI-RS, aperiodic CSI-RS, or PDSCH has a scheduling offset larger than the threshold in a serving cell, the UE may buffer data based, at least in part, on a spatial relation (e.g., QCL) assumption for the serving cell. In some instances, when the UE supports simultaneous multi-beam reception, the UE may determine a second default beam to buffer downlink data based, at least in part, on at least one of common TCI states included in a TCI state list for a serving cell indicated in one of a MAC CE received from the base station, a DCI received from the base station, a QCL assumption for CORESETs in a most recent slot or TCI states for CORESETs in a most recent slot.

In some instances, the UE may determine, based, at least in part, on the TCI state list, an operational mode for one or more serving cells associated with one or more TRPs. Additionally, the UE may communicate with the one or more serving cells according to the determined operational mode. In some instances, when a TCI state list is not configured for a serving cell of the one or more serving cells, the UE may receive, from the base station, an indication of at least one of a reference bandwidth part, a reference component carrier, or a reference TRP for the serving cell. In some instances, the UE may receive, from the base station, an indication of at least one of a reference bandwidth part or reference component carrier for a serving cell of the one or more serving cells. The indication may identify an additional TCI state list for multi-TRP operation. In some instances, the indication may be received via radio resource control signaling.

In some instances, the UE may receive, from the base station, an indication of the TCI state list including a plurality of TCI states for a serving cell of the one or more serving cells and may determine which of the plurality of TCI states in the TCI state list is applicable for the serving cell for single TRP operation. In some instances, the determination may be made by (e.g., based, at least in part, on) applying a first TCI state in the list of TCI states for the serving cell for single TRP operation, applying a last TCI state in the list of TCI states for the serving cell for single TRP operation, applying a TCI state with a lowest TCI index in the list of TCI states for the serving cell for single TRP operation, applying a TCI state with a highest TCI index in the list of TCI states for the serving cell for single TRP operation, and/or applying a TCI state as indicated by the base station for the serving cell for single TRP operation.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a UE 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method for supporting a multi-beam indication, comprising:
a user equipment device (UE),
receiving, from a base station, at least one transmission configuration indicator (TCI) state list corresponding to one or more transmission-reception points (TRPs);
determining, based at least in part on the at least one TCI state list, an operational mode for one or more serving cells associated with the one or more TRPs; and
communicating with the one or more serving cells according to the determined operational mode.

2. The method of claim 1,
wherein, when a TCI state list is not configured for a serving cell of the one or more serving cells, the method further comprises the UE receiving, from the base station, an indication of at least one of a reference bandwidth part, a reference component carrier, or a reference TRP for the serving cell.

3. The method of claim 1, further comprising:
the UE,
receiving, from the base station, an indication of at least one of a reference bandwidth part or reference component carrier for a serving cell of the one or more serving cells, wherein the indication identifies an additional TCI state list for multi-TRP operation.

4. The method of claim 3,
wherein the indication is received via radio resource control signaling.

5. The method of any of claims 1 to 4, further comprising:
the UE,
receiving, from the base station, an indication of a TCI state list including a plurality of TCI states for a serving cell of the one or more serving cells; and
determining which of the plurality of TCI states in the TCI state list is applicable for the serving cell for single TRP operation based on at least one of:
applying a first TCI state in the list of TCI states for the serving cell for single TRP operation;
applying a last TCI state in the list of TCI states for the serving cell for single TRP operation;
applying a TCI state with a lowest TCI index in the list of TCI states for the serving cell for single TRP operation;
applying a TCI state with a highest TCI index in the list of TCI states for the serving cell for single TRP operation; or
applying a TCI state as indicated by the base station for the serving cell for single TRP operation.

6. The method of any of claims 1 to 5, further comprising:
wherein, when the at least one TCI state list includes a plurality of TCI states, the method further comprises the UE,
determining a default beam to buffer downlink data to receive an aperiodic Channel State Information (CSI) reference signal (CSI-RS) or a physical downlink shared channel with a scheduling offset less than a threshold based on common TCI states included in a TCI state list for a serving cell indicated in one of a medium access control (MAC) control element (CE) or downlink control information (DCI) received from the base station.

7. The method of claim 6,
wherein, when the UE does not support simultaneous reception of multiple beams, the UE selects a TCI state from the common TCI states to buffer downlink data based on at least one of:
selecting a first TCI state in the list of TCI states;
selecting a last TCI state in the list of TCI states;
selecting a TCI state in the TCI state list as indicated by the base station; or
selecting a TCI state in the TCI state list based on one of a sub-slot index, slot index, subframe index, or frame index.

8. The method of any of 6 or 7,
wherein, when the UE does support simultaneous reception of multiple beams, the UE selects the common TCI states to buffer downlink data.

9. The method of any of claims 6 to 8,
wherein, when a spatial receive parameter assumption for indicated TCI states for multiple serving cells within a band or band group are different, the method further comprises the UE,
selecting TCI states to buffer downlink data across the multiple serving cells based on priority of a serving cell within the multiple serving cells.

10. The method of claim 9,
wherein the priority is based on at least one of cell type, cell TRP operation, or cell index.

11. The method of claim 10,
wherein, when the priority is based on cell type, a primary serving cell within the multiple serving cells has a higher priority than a secondary serving cell within the multiple serving cells.

12. The method of any of claims 10 to 11,
wherein, when the priority is based on cell TRP operation, a serving cell within the multiple serving cells operating as a single TRP has a higher priority than a serving cell within the multiple serving cells operating as a multiple TRP.

13. The method of any of claims 10 to 12,
wherein, when the priority is based on cell index, a serving cell within the multiple serving cells with a lower index has a higher priority than a serving cell within the multiple serving cells with a higher index.

14. The method of any of claims 6 to 13,
wherein the threshold is reported by UE capability.

15. The method of any of claims 1 to 5, further comprising:
the UE,
determining a default beam to buffer downlink data to receive an aperiodic Channel State Information (CSI) reference signal (CSI-RS) or a physical downlink shared channel with a scheduling offset less than a threshold based on at least one of quasi-co-location (QCL) assumption or TCI states for Control Resource Sets (CORESETs) in a most recent slot.

16. The method of claim 15,
wherein determining the default beam to buffer downlink data includes the UE identifying at least one of the QCL assumption or the TCI states based on configuration and priority for the CORESETs and associated search spaces (SSs).

17. The method of claim 16,
wherein the priority is based, at least in part on section 10.1 of 3GPP technical specification 38.213.

18. The method of any of claims 15 to 17, further comprising:
the UE,
buffering downlink data across serving cells in a band based on the determined QCL information or TCI states.

19. The method of any of claims 15 to 18,
wherein the threshold is reported by UE capability.

20. The method of any of claims 6 to 19,
wherein, when at least one of a semi-persistent CSI-RS, periodic CSI-RS, aperiodic CSI-RS, or PDSCH has a scheduling offset larger than the threshold in a serving cell, the method further comprises the UE buffering data based, at least in part, on a QCL assumption for the serving cell.

21. The method of any of claims 6 to 20,
wherein, when the UE supports simultaneous multi-beam reception, the method further comprises the UE determining a second default beam to buffer downlink data based on at least one of common TCI states included in a TCI state list for a serving cell indicated in one of a MAC CE received from the base station, a DCI received from the base station, a QCL assumption for CORESETs in a most recent slot or TCI states for CORESETs in a most recent slot.

22. A computer program product, comprising computer instructions which, when executed by one or more processors, perform steps of the method of any of claims 1 to 21.

23. A user equipment device (UE), comprising:
one or more processors; and
a memory having instructions stored thereon, which when executed by the one or more processors, perform steps of the method of any of claims 1 to 21.
